(19) United States
(12) Patent Application Publication
(10) Pub. No.: US 2008/0284283 A1
(43) Pub. Date: Nov. 20, 2008

(54) Piezo Stack With Novel Passivation

(76) Inventors: Michael Kaspar, Putzbrunn (DE); Carsten Schuh, Baldham (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/095,439

(22) PCT Filed: Jan. 4, 2007
(86) PCT No.: PCT/EP07/50073

§ 371 Date: May 29, 2008

(30) Foreign Application Priority Data
Jan. 11, 2006 (DE) 10 2006 001 502.9
Jan. 19, 2006 (DE) 10 2006 002 695.0

(51) Int. Cl. H02N 2/00; H04R 17/00

(52) U.S. Cl. 310/321; 29/25.35

(57) ABSTRACT

An electrical passivation of surfaces of an electronic component which have electrodes is intended to be carried out in simple and effective fashion and also to be stable in chemically and thermally unfavourable environments. For the passivation, a plastic film, for example made of epoxy, is laminated onto the surface. Applications are in fuel injection systems, for example.

### CROSS-REFERENCE TO RELATED APPLICATIONS

This application is a U.S. national stage application of International Application No. PCT/EP2007/050073 filed Jan. 4, 2007, which designates the Unites States of America, and claims priority to German application number 10 2006 001 502.9 filed Jan. 11, 2006 and German application number 10 2006 002 695.0 filed Jan. 19, 2006, the contents of which are hereby incorporated by reference in their entirety.

### TECHNICAL FIELD

The present invention relates to a method for electrical passivation of surfaces of electronic components featuring electrodes and to the electronic components produced accordingly. Such components can for example be multilayer piezo stacks, piezoelectric bending converters and monolithic piezo components.

### BACKGROUND

US 2004/135235 A1 discloses an integrated circuit structure, for example a semiconductor device with a self-passivating copper laser contactor featuring a passivation area. The laser contactor has passivation areas on open copper surfaces of the contactor.

U.S. Pat. No. 5,629,531 A discloses an arrangement of a silicon carbide device with a thermally created oxide passivation layer which is substantially free of dopants, is electrically highly integrated and has small quantities of aluminum or carbon oxides.

Because of the given performance requirements the design of known piezoceramic multilayer actuators or multilayer sensors conventionally includes inner electrodes which are routed completely to the side surfaces of the stack. These inner electrodes have an active contact area which is kept as small as possible. This means that a large part of the side actuator/sensor surface is electrically active. This must therefore be electrically passivated for use in order in particular to avoid short circuits. The passivation is provided in the conventional manner by applying silicon elastomers to the ceramic surface.

In particular the passivation, which corresponds to a provision of electrically inactive side surfaces, is expensive to produce for multilayer piezo stacks. In particular conventional passivations are not able to sufficiently withstand chemical stresses. Further problems are involved with the adhesion of the passivation to the ceramic surfaces of the component. Conventionally the passivation requires large amounts of space but dissipates heat poorly. When piezo stacks are used in the automotive industry non-swellable passivation materials in particular are required in connection with fuel. Also problematic in the prior art is the passivation of irregularly-shaped rough and uneven surfaces of electrical or electronic components respectively. Further problems arise if a number of side surfaces of a component are to be coated simultaneously. This relates especially to two side surfaces lying opposite one another.

### SUMMARY

Surfaces of an electrical component, especially side surfaces of a multilayer piezostack, of a piezoelectric bending transducer or of a monolithic piezo component can be electrically passivated in a simple and effective manner. Use is to be guaranteed in chemically and thermally unfavorable environments.

According to an embodiment, a method for electrical passivation of at least one surface of at least one electronic component featuring an electrode of a piezoelectric bending transducer or of a monolithic piezo component, may comprise
the steps below executed in any given consecutive order or simultaneously:
   Application of an electrical insulation to the surface of the electronic components,
   Creation of openings in the insulation in the area of the electrodes.

According to a further embodiment, a plastic foil or a plastic sleeve can be laminated on as insulation, featuring an epoxide or polyimide. According to a further embodiment before the insulation is applied, electrode areas may be covered or sealed to prevent adhesion of the insulation, for example by means of Kapton foil or metallic structures. According to a further embodiment, the openings can be created by mechanical or physical removal of the insulation. According to a further embodiment, an insulation is printed on, by means of an ink jet method for example, and is hardened by means of UV radiation and/or temperature. According to a further embodiment, the insulation may be physically and chemically stable in relation to fuel. According to a further embodiment, after the application of the electrical insulation and after the creation of the openings, a surface electrical contacting of the electrode areas can be undertaken. According to a further embodiment, the surface electrical contacting can be undertaken by means of a flexible leadframe.

An electronic component can be created in accordance with the above described method.

### BRIEF DESCRIPTION OF THE DRAWINGS

The present invention will be described in greater detail on the basis of exemplary embodiments in connection FIGS. 1 to 4. The figures show

FIG. 1 a first exemplary embodiment of an electrical passivation of a surface of an electrical component;

FIG. 2 a second exemplary embodiment of a passivation of a side surface of an electronic component;

FIG. 3 a third exemplary embodiment of an electrical passivation of a side surface of an electronic component;

FIG. 4 a fourth exemplary embodiment of a passivation of a side surface of an electronic component;

FIG. 5 an exemplary embodiment of an electrically passivated component.

### DETAILED DESCRIPTION

The application of an electrical insulation to the surface of the electronic components, as well as a creation of openings in the insulation in the area of electrodes can be undertaken in any order. Likewise a simultaneous application while leaving openings free at the same time is possible.

In accordance with an embodiment a plastic foil is especially laminated onto a piezoceramic multilayer stack of conventional design for electrical passivation of the side surfaces. This plastic foil features an epoxide or polyimide respectively for example. As regards the electrical contacting the reader is referred to the known Siemens-internal contacting by means of planar structures, especially metal structures.

The provision of an electrical passivation in accordance with an embodiment has the following advantages. The insulation layer provided can be provided thermally stable up to appr. 200° C. The materials used are likewise able to resist heavy chemical stresses. Applications can be found for example in vehicle fuel injection. Because of the lamination process, especially in autoclaves or in high-pressure vacuum presses, a very good adhesion, especially to piezoceramic surfaces, can be provided. As a result of the narrow thickness of the created passivation layers according to various embodiments the space required around the passivated component is small. A further effect of the narrow thickness of the passivation layer created is enhanced heat dissipation characteristics, especially in dynamic operation of actuators or sensors. Especially when used in automotive technology, in conjunction with fuels, chemically-stable, especially non-swellable passivation materials can be used. As a result of the novel passivation method especially irregularly shaped, rough or uneven surfaces or surfaces which are unfavorable in any other way, especially of piezo stacks, can be passivated. Likewise plastic sleeves can be used for a simultaneous coating of four side surfaces, especially of a piezo stack. Likewise, by means of an lamination process according to various embodiments, two opposing side surfaces can be laminated in a simple manner. The use of conventional ink jet methods is likewise possible. In this way a direct structuring of the passivating insulation layers can be undertaken.

Advantageously a plastic foil or a plastic sleeve, featuring for example epoxides or polyimides, can be laminated on as the insulation for example. This means that the advantages mentioned above can be implemented in an especially simple manner.

Especially advantageously, before the application of the insulation, electrode areas, for example, may be covered or sealed by means of Kapton foil or metallic structures to prevent the adhesion of the insulation.

The openings can be created in a simple manner by mechanical or physical removal of the insulation.

Especially advantageously a layer of insulation can be printed on as insulation in a simple manner, for example by means of an ink jet method, and hardened using UV radiation and/or temperature.

For insulation against fuel physically and chemically stable materials in particular can be used.

In accordance with an embodiment, after the application of the electrical insulation and after the creation of the openings a surface electrical contacting of the electrode areas is undertaken. This enables conventional methods such as bonding for example to be avoided and electrical contacting to be provided in a simple manner.

It can be especially advantageous for the surface electrical contacting to be undertaken using a flexible leadframe.

The area of protection claimed by the present application likewise includes electronic components which were created according to such a method.

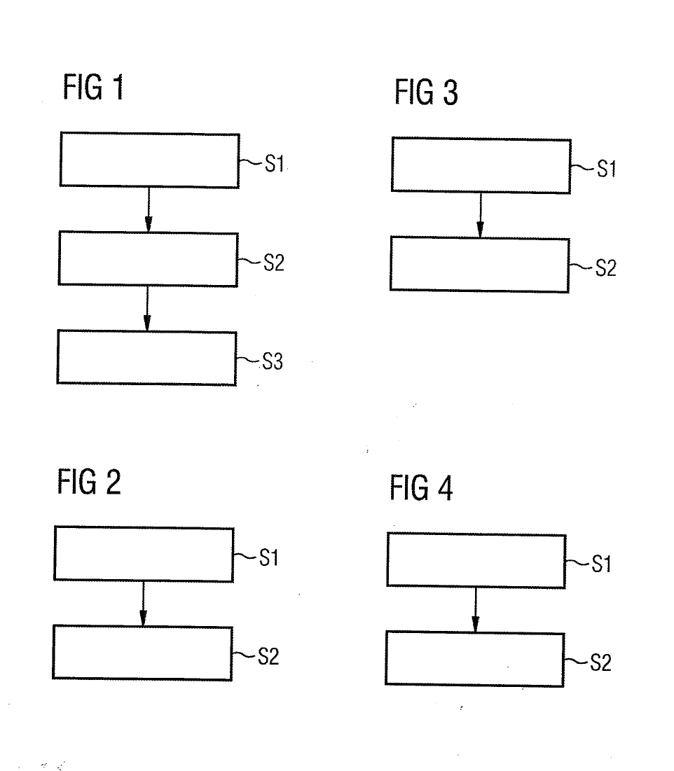

FIG. 1 shows a first exemplary embodiment of an electrical passivation. In this case the necessary contacting areas of an electrical or electronic component, especially of a piezo stack are covered or sealed with a first method step S1, before the application of an insulation with a second method step S2. The surfaces can be covered for example by means of a Kapton foil or by means of metallic structures. The sealing is designed to prevent the adhesion of an insulation provided with the second method step S2 by means of a lamination foil. The sealing explicitly allows areas to be excluded from the lamination process executed in the second method step S2. Non-laminated foil surfaces can be removed for example by means of mechanical processing with a third method step S3.

FIG. 2 shows a second exemplary embodiment of an electrical passivation. In accordance with this exemplary embodiment, the passivation layer is structure after the lamination undertaken with a first method step S1. This is done with a second method step S2 by physical removal for example by means of laser processing after the lamination. During this removal or this laser processing contact surfaces are explicitly opened.

FIG. 3 shows a third exemplary embodiment of an electrical passivation. In accordance with this exemplary embodiment a prestructured insulating foil is created with a first method step S1. The structuring is undertaken for example by punching. Then, with a second method step S2 the prestructured insulating foil is laminated onto the side surface of the electronic or electrical component to be passivated.

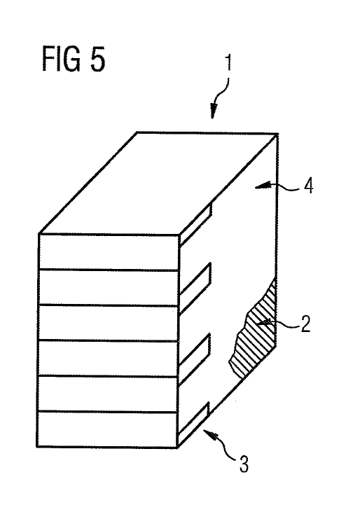

FIG. 4 shows a fourth exemplary embodiment of an electrical passivation. In accordance with this exemplary embodiment an insulating layer is printed directly with a first method step S1, for example by means of an Ink jet method, onto the surface to be passivated. Then, with a second method step S2, the insulation is hardened off by means of UV radiation or by utilizing a specific temperature range. The openings required for contacting are kept free. No printing onto these areas thus takes place.

FIG. 5 shows an exemplary embodiment of an electrically passivated piezo multilayer stack 1 with electrodes 3 brought out at side surfaces 2 and an associated passivation layer 4. The passivation layer 4 is provided with openings in the area of the electrodes 3.

The inventive method is not restricted to the passivation of piezo multilayer stacks. Further possible uses can be found for electronic components such as piezoelectric bending transducers or monolithic piezo components. Also covered by the scope of protection are all electronic or electrical components created with this method. The exemplary embodiments are merely embodiments and do not restrict the scope of protection of the present invention.

What is claimed is:

1. A method for electrical passivation of at least one surface of at least one electronic component featuring an electrode of a piezoelectric bending transducer or of a monolithic piezo component, the method comprising the steps below executed in any given consecutive order or simultaneously:
Application of an electrical insulation to the surface of the electronic components,
Creation of openings in the insulation in the area of the electrodes.

2. The method according to claim 1, wherein,
a plastic foil or a plastic sleeve is laminated on as insulation, featuring an epoxide or polyimide.

3. The method according to claim 1, wherein,
before the insulation is applied, electrode areas are covered or sealed to prevent adhesion of the insulation.

4. The method according to claim 1, wherein
the openings are created by mechanical or physical removal of the insulation.

5. The method according to claim 1, wherein
an insulation is printed on and is hardened by means of UV radiation or temperature.

6. The method according to claim 1, wherein
the insulation is physically and chemically stable in relation to fuel.

7. The method according to claim 1, wherein
after the application of the electrical insulation and after the creation of the openings, a surface electrical contacting of the electrode areas is undertaken.

8. The method according to claim 7, wherein
the surface electrical contacting is undertaken by means of a flexible leadframe.

9. An electronic component, created in accordance with a method as claimed in claim 1 comprising:
an electrical insulation on the surface of the electronic components, and
openings in the insulation in the area of the electrodes.

10. The electronic component according to claim 9, wherein,
the insulation is a plastic foil or a plastic sleeve laminated on as insulation, featuring an epoxide or polyimide.

11. The electronic component according to claim 9, wherein,
the insulation is physically and chemically stable in relation to fuel.

12. The electronic component according to claim 9, a surface electrical contacting of the electrode areas.

13. The electronic component according to claim 12, wherein
the surface electrical contacting is a flexible leadframe.

14. The method according to claim 1, wherein,
before the insulation is applied, electrode areas are covered or sealed to prevent adhesion of the insulation by means of Kapton foil or metallic structures.

15. The method according to claim 1, wherein
an insulation is printed on by means of an ink jet method and is hardened by means of UV radiation or temperature.

16. The method according to claim 1, wherein
an insulation is printed on and is hardened by means of UV radiation and temperature.

17. A method for electrical passivation of at least one surface of at least one electronic component featuring an electrode of a multilayer piezoelectric device, the method comprising the steps below executed in any given consecutive order or simultaneously:
Application of an electrical insulation to the surface of the electronic components,
Creation of openings in the insulation in the area of the electrodes.

18. The method according to claim 17, wherein,
a plastic foil or a plastic sleeve is laminated on as insulation, featuring an epoxide or polyimide.

19. The method according to claim 17, wherein,
before the insulation is applied, electrode areas are covered or sealed to prevent adhesion of the insulation.

20. The method according to claim 17, wherein
the openings are created by mechanical or physical removal of the insulation.
